(19) United States
(12) Patent Application Publication
(10) Pub. No.: US 2018/0160746 A1
(43) Pub. Date: Jun. 14, 2018

(54) SLIDEABLE AND ABRASION RESISTANT FLEXIBLE IMPACT ABSORBING CUSHIONING PADS, CLOTHING INCORPORATING SUCH PADS, AND METHODS OF MAKING AND USING

(71) Applicant: G-Form, LLC, Providence, RI (US)

(72) Inventors: Daniel M. WYNER, North Scituate, RI (US); Maria E. MACRINA, Providence, RI (US); Richard L. GARRARD, Providence, RI (US)

(73) Assignee: G-Form, LLC, Providence, RI (US)

(21) Appl. No.: 15/891,971

(22) Filed: Feb. 8, 2018

Related U.S. Application Data
(63) Continuation of application No. 13/618,610, filed on Sep. 14, 2012, now abandoned.
Application No. 13/618,610 is a continuation-in-part of application No. 13/208,229, filed on Aug. 11, 2011, now Pat. No. 9,782,662.
(60) Provisional application No. 61/534,871, filed on Sep. 14, 2011.

(51) Int. Cl. A41D 13/015; B32B 27/40; B32B 5/24; B32B 5/18

(52) U.S. Cl. CPC A41D 13/015; B32B 2571/00; B32B 2437/00; B32B 2266/0278; A63B 71/08; B32B 5/245; B32B 5/18; B32B 27/40

(57) ABSTRACT

The present disclosure relates to flexible and conformable protection pads with cushioning regions that include integral abrasion resistant and/or slideable upper surfaces, or abrasion resistant and/or slideable shells that conform to the outer surface of the cushioning regions, which may extend downwardly from the cushioning region and may have tapered edges.

### CROSS REFERENCE TO RELATED CASES

This application is a Continuation-in-Part under 35 U.S.C. § 120 of commonly-owned and co-pending U.S. application Ser. No. 13/208,229, filed on Aug. 11, 2011, and also claims priority under 35 U.S.C. § 119(e) to commonly-owned and co-pending U.S. Provisional Application No. 61/534,871, which was filed on Sep. 14, 2011. The subject matter of each of the foregoing applications is incorporated herein by reference in its entirety.

### TECHNICAL FIELD

The disclosure relates to conformable protection pads, with abrasion resistant and/or slideable surfaces, articles that include such pads, methods of making and using the pads.

### BACKGROUND

Many activities, especially athletic activities, involve potential risk to the body from impact. Elbows, knees, shoulders, ankles, hips and other joints can be especially susceptible to impact damage and yet are challenging to protect without restricting the range of motion and movement of the individual. Impact protection can be heavy, non-breathable or restrictive, or alternatively does not target certain body parts accurately, or does so inconsistently.

In some instances, it also may be desirable to have an abrasion resistant surface, a surface with sliding characteristics, or both.

A need exists for improved impact absorbing and abrasion resistant protective padding, particularly for areas requiring range of motion, and for joints.

### SUMMARY

The present disclosure is directed, in one embodiment, to a cushioning pad A cushioning pad. The cushioning pad comprises a cushioning region with an upper surface, a lower surface, a thickness and a width. The cushioning region includes a cushioning material disposed between and continuously bonded to a continuous upper layer and a continuous lower layer. A channel is disposed around and defining the cushioning region, and the channel comprises a thickness less than the thickness of the cushioning region. The channel further comprises the continuous upper layer and the continuous lower layer, and the continuous upper layer is at least partially bonded to the continuous lower layer. An abrasion resistant material can comprises the continuous upper layer and/or can be an additional layer disposed over the upper layer.

### BRIEF DESCRIPTION OF THE DRAWINGS

The foregoing and other features and advantages will be apparent from the following more particular description of exemplary embodiments of the disclosure, as illustrated in the accompanying drawings, in which like reference characters refer to the same parts throughout the different views. The drawings are not necessarily to scale, emphasis instead being placed upon illustrating the principles of the disclosure.

FIG. 1 is a top view of one exemplary cushioning pad according to the present disclosure, with various cushioning regions;

FIG. 2 is a schematic side view of the cushioning pad of FIG. 1, through line 2-2;

FIG. 3 is a schematic side view of the cushioning pad of FIG. 1, through line 3-3;

FIG. 4 is a top view of another exemplary cushioning pad according to the present disclosure, including a shell on one or more of the cushioning regions;

FIG. 5 is a schematic side view of the cushioning pad of FIG. 4, through line 5-5;

FIG. 6 is a schematic side view of the cushioning pad of FIG. 4, through line 6-6;

FIG. 7 is an enlarged side view of a portion of the cushioning pad of FIG. 5, showing the direction of applying a pre-formed shell onto a medallion; and

FIG. 8 is an enlarged side view of an alternate embodiment of a shell disposed onto a medallion, and attached thereto by a fastener.

### DETAILED DESCRIPTION OF EXEMPLARY EMBODIMENTS

The present disclosure is directed to cushioning pads that have improved abrasion-resistant and/or slideable surfaces, to clothing incorporating the pads, and to methods of making the pads and clothing. The cushioning pads include cushioning regions of various shapes, sizes, configurations and thicknesses. For ease of discussion, the terms “cushioning region” and “medallion” will used interchangeably throughout the description. Various materials can be used for the medallions, as will be described below. The medallions are spaced apart by channels of various depths and configurations, which define the perimeter of the medallions, and function as flexible “hinges”.

The medallions are spaced apart by channels of various depths and configurations, which define the perimeter of the medallions. The upper surface of the medallions may include grooves of various depths and configurations, which define, in part, the contours of the medallions. In some instances, a perimeter flange is provided, spaced apart from the perimeter of the pad.

The combination of the medallions, channels, grooves and flange, as well as the materials from which the pads are formed, together provide various functional characteristics to the pad. For example, the channels are deeper than the grooves, and are configured to provide unrestricted, free range of motion in critical areas, such as around joints. The grooves are shallower than the hinges, and provide flexibility, while retaining some cushioning and/or impact resistance. However, it should be understood that both the channels and the grooves function as “hinges,” providing the pad with multilevel hinging.

The present cushioning pads can be incorporated into clothing, and can be designed to have specific functional characteristics, including mobile protection to areas of the body that flex, particularly joints. The padding can be incorporated into garments such that garment materials fit snugly, but stretch and conform to the body, or to a specific joint shape, resulting in an integrated padding system that protects the wearer from impact better than other products, because the pad is in constant and direct contact with the wearer during the full range of motion.

Garments incorporating the present pads provide improved protection from injury when worn, because the base of the pad, or the material to which the base of the pad is attached, can be maintained in direct contact with the user's body during use, when incorporated into clothing that stretches and fits snugly, such as compression clothing. The flexibility of the pads allows the pads to conform to a user's body shape, so that the pad can be maintained in contact with the user's body. That is, without the degree of flexibility of the present pads, the pads would not be capable of conforming to the changing body contours of the user, while in motion. For ease of discussion, the term “flexible,” as used herein, means the ability of the pad to move by bending, twisting, flexing and/or stretching, and the like.

By combining specific shapes, sizes, configurations, contours and orientations of the medallions, hinges, grooves and/or a perimeter flange, with specific pad and clothing materials, garments can be designed to maximize a user's free range of motion, while protecting specific, targeted areas of the body, particularly joints. Such garments are aesthetically pleasing, more durable, lower in cost, more breathable and comfortable, and provide significant range of motion and targeted, accurate, protection to the body.

In one exemplary embodiment comprising a continuously bonded multi-layer construction, the present pads and items including such pads provide items that are rugged, durable, and able to withstand the temperatures, detergents and mechanical action used in industrial and/or commercial laundering, unlike other padded clothing, which tends to degrade under such harsh conditions. The presence of the continuous bond between the layers in the hinges is advantageous because it “locks” the medallions in place, minimizing or preventing the egress of cushioning material from the pad or, alternatively, minimizing or preventing the ingress of materials, such as fluids, into the pads. Therefore, the hinges stabilize the pads, particularly the cushioning material, such that fluids and other materials are not able to penetrate the pad, which might otherwise lead to delamination. The presence of the vents, which are also continuously bonded, maximizes the breathability and ventilating ability of the pads, without compromising the durability and washability of the pads.

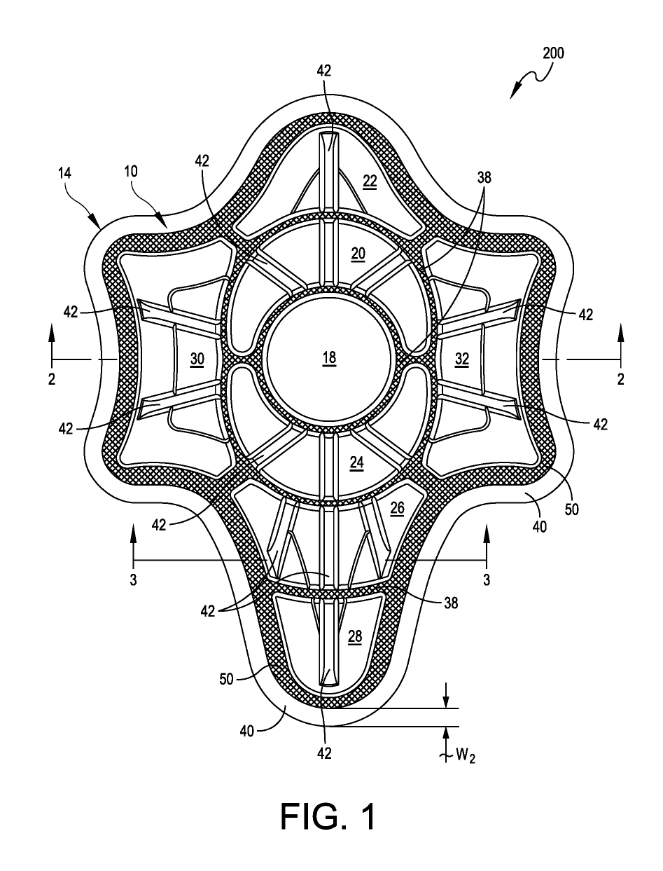

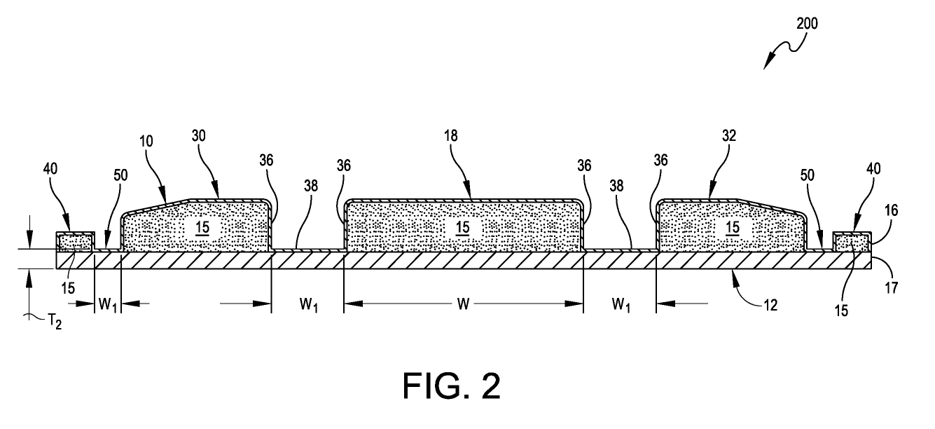

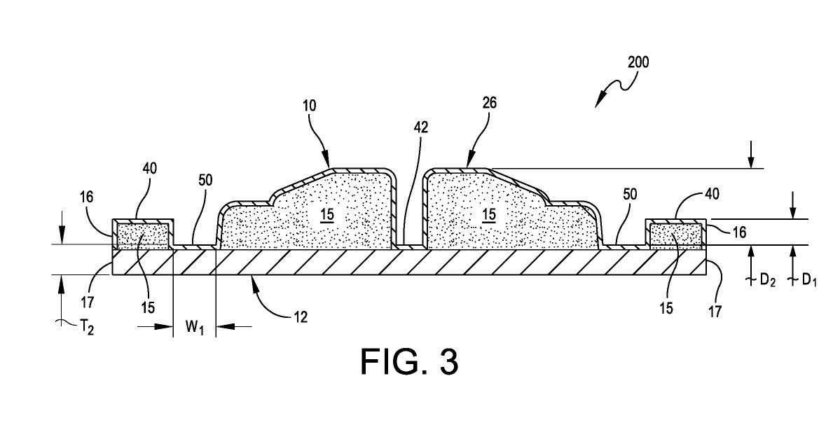

FIGS. 1-3, when taken together, illustrate one exemplary cushioning pad 200 according to the present disclosure. Pad 200 has a shape, size and configuration adapted to the contours of an elbow joint, as noted above, but it should be understood that the pad can comprise any shape, size or configuration as is practical or desired for a particular design or application. Pad 200 comprises a front surface 10, a back surface 12 and an outer edge/perimeter 14, with a cushioning layer 15 disposed between optional outer and inner layers 16,17.

Pad 200 comprises least one cushioning region disposed in the upper surface 10. For ease of discussion, the terms “cushioning region” and “medallion” will used interchangeably throughout the description. In the present exemplary embodiment, pad 200 comprises medallions 18, 30 and 32, each of which comprises an upper surface 34 and a sidewall 36 extending downwardly to the upper surface 10 of the pad 100. The sidewalls 36 may be perpendicular to the upper surface 34, or have an angled profile relative to the upper surface 34, coming to a point at the bottom of the hinge or groove. Optionally, one or more grooves 42 may be formed in the upper surface 34 of the medallions.

Hinges 38 are defined in pad 200, to maintain the medallions in spaced apart relation, and to provide flexibility to the pad. The hinges 38 have a width “W1” defined by the spacing between the perimeter of adjacent medallions, and a depth “D1” defined by the spacing between the upper surface 34 of the medallions the upper surface 10 of the pad 200, and a thickness “T2” defined by the combined thicknesses of the inner and outer layers 16,17 and the cushioning material 15, if any, disposed between the layers.

Pad 200 also comprises a perimeter hinge 50, which corresponds to the shape of the perimeter of the pad. Like hinge 38, perimeter hinge 50 has a width “W1” defined by the spacing between the perimeter of adjacent medallions and perimeter flange 40, a depth “D1” defined by the spacing between the upper surface 34 of the medallions and the upper surface 10 of the pad 200, and a thickness “T2” defined by the combined thicknesses of the inner and outer layers 16,17 and the cushioning material 15, if any, disposed between the layers.

As noted above, the present cushioning pads have improved abrasion-resistance and/or slideable surfaces, and such surfaces can be achieved using different construction techniques and methods, as described below.

In some embodiments, the outer layer 16 can comprise a moldable polymer material that has the desired characteristics for the outermost surface of the cushioning pad 200, and that is capable of being co-molded with the cushioning pad 200. Outer layer 16 can comprise any thickness suitable for the intended application, provided that the material at the desired thickness can be co-molded with cushioning pad 200. Examples of suitable materials for the outer layer 16 include, but are not limited to, acrylic, polyamide (“Nylon”), polycarbonate (“PC”), polyethylene (“PE”), polyoxymethylene (“POM”), polypropylene (“PP), polytetrafluoroethylene (“PTFE”), compounds thereof, including one or more additives, modifiers, fillers and/or colorants, and combinations of the foregoing. If desired, the outer layer can comprise one or more additives, modifiers, fillers and/or colorants to impart different aesthetic and/or functional characteristics. Some suitable materials are used for INVISALIGN® braces, which have good abrasion resistance and/or flexibility, and are described in various U.S. patents owned by Align Technologies, Inc. (“Align”). Representative patents owned by Align include, but are not limited to, U.S. Pat. Nos. 5,975,893, 6,964,564 and 7,641,828.

In some embodiments, in which greater abrasion resistance and/or high strength is desired, the inner and/or outer layers 16, 17 can comprise a fabric that has the desired abrasion-resistant and/or sliding characteristics for the intended application. Outer layers 16,17 can comprise any thickness suitable for the intended application, provided that the material at the desired thickness can be co-molded with cushioning pad 200. Examples of such materials include, but are not limited to, reinforced and un-reinforced polyester, nylon, rayon, polyamides (such as aramids and para-aramids), and the like, and combinations thereof. Examples may include CORDURA™ fabric, KEVLAR™ fiber, TWARON™ fiber, SPECTRA™ fiber, ZYLON™ fiber, ripstop weaves thereof, and combinations thereof.

If the ballistic fabric is not capable of being co-molded with the cushioning pad 200, then it could be attached to the outer surface of the medallions using a variety of attachment techniques including, but not limited to, sewing, gluing, and the like. Alternatively, the inner layer 17 of cushioning pad 200 could be attached to the ballistic fabric, and the pad could be inverted in use, such that ballistic material functions as the outermost layer. Outer layers 16,17 can comprise any thickness suitable for the intended application.

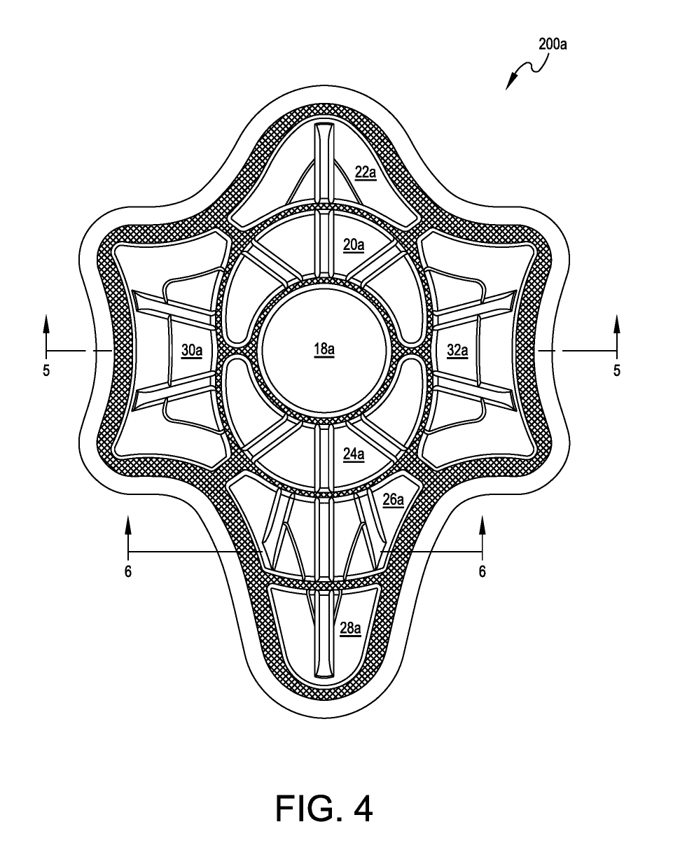

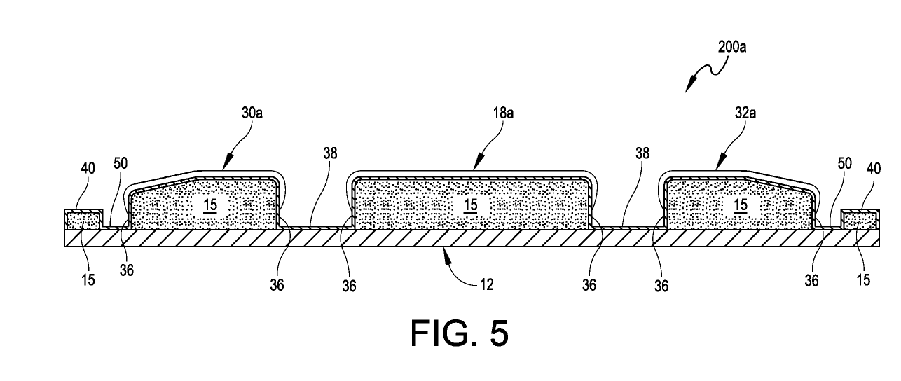

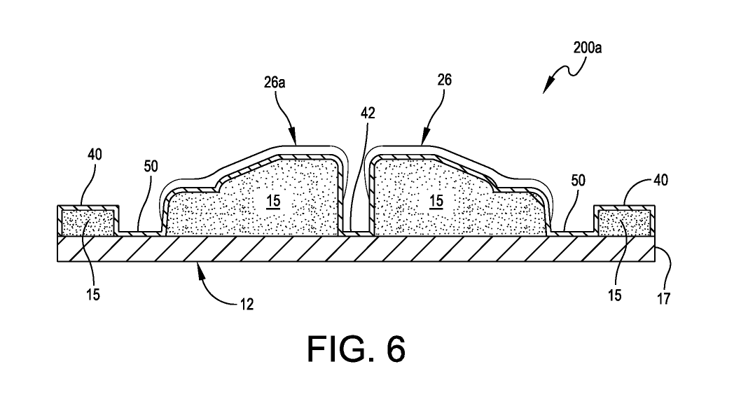

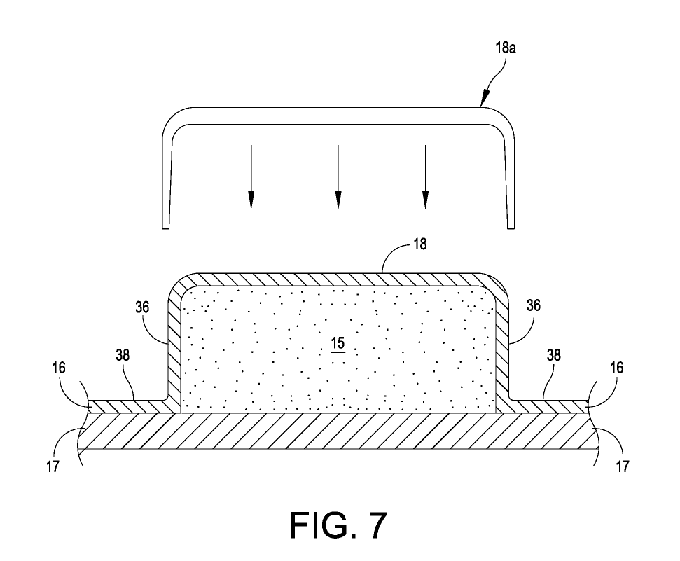

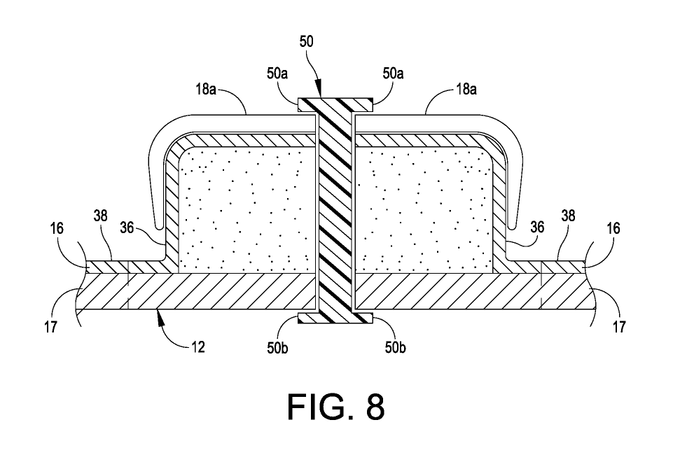

In some embodiments of the present disclosure, one or more shells can be disposed over one or more of medallions 18, 30 and 32. As shown in FIGS. 4-6, cushioning pads 200a comprises shells 18a, 30a and 32a disposed over one or more of medallions 18, 30 and 32. It may be desirable for the shells to conform to the outer surface of the medallions to which they are attached. In the present embodiment, the shells conform to the upper surface of the medallions. Optionally, the shells may comprise a flange 260 that extends downwardly on the sidewall 36, at least a portion of the distance between the upper surface of the medallion to the upper surface of the hinge. For example, if desired, flange 260 may extend about ¼ to about ¾ of the distance from the upper surface of the medallion to the upper surface of the hinge. Alternatively, if desired, flange 260 can extend downwardly about the entire distance from the upper surface of the medallion to the upper surface of the hinge. In some embodiments, it may be desirable for the flange to have a tapered or beveled edge (as shown in FIGS. 7 and 8), which may prevent or minimize the flange edge from “catching” onto an outer surface of the medallion, or to other surfaces brought into adjacent relation to the medallions (for example, to the interior of a garment worn over a cushioning sleeve incorporating one of the cushioning pads).

The shells can be applied to the outer layer of the medallions using a variety of techniques, including gluing, welding, heat sealing, and using a fastener. Depending on the technique, the bonding between layers 16,17 may be at least partially a chemical, thermal and/or mechanical bond. As shown in FIG. 8, a the shell may be fastened to the pad by a fastener extending through the medallion from the upper surface to the lower surface. A variety of fasteners may be used, including rivets, nuts, bolts, studs, screws, washers, eyebolts, nails, threaded fasteners, combinations thereof, and the like. The fasteners may be formed from a variety of materials including, but not limited to, plastics, composites, metal, and combinations thereof.

Shells 18a, 30a and 32a can be formed from a polymer material that has the desired characteristics for the outermost surface of the cushioning pad 200. It may be desirable for the material to be capable of being co-molded with the cushioning pad 200, although it could be formed separately using a variety of techniques known to those of skill in the art. Suitable materials for the shells 18a, 30a and 32a are the same as those described above with regard to the previous embodiment. Shells 18a, 30a and 32a can comprise any thickness suitable for the intended application, provided that if co-molded, the material at the desired thickness can be co-molded with cushioning pad 200.

In another embodiment, the outer layer 16 can comprise an unbonded loop material (“UBL”) that is capable of being co-molded with the cushioning pad 200, such that the loops extend outwardly from the outer surface. Shells 18a, 30a and 32a could be molded separately to comprise an inner surface with a corresponding hook material, by which the shells 18a, 30a and 32a could be attached to the UBL outer layer 16. In some embodiments, the loop can be bonded to a shock absorbing material.

In another embodiment of the present disclosure, shells 18a, 30a and 32a can be formed on medallions 18, 30 and 32 by applying a curable resin to at least a portion of the outer surface of one or more of the medallions. Method of applying the uncured resin include, but are not limited to, dip coating, spray coating, and the like. After application of the resin, it is allowed to cure and form a hard shell. One suitable resin is available from 3M under the brand name SCOTCH-WELD™ 2216 B/A epoxy adhesive. Shells 18a, 30a and 32a can comprise any thickness suitable for the intended application, provided that if co-molded with cushioning pad 200, the desired thickness is suitable for co-molding. Optionally, successive layers of the resin can be applied in order to maximize the thickness of the shells, if desired or needed.

In another embodiment of the present disclosure, shell pre-forms can be disposed onto medallions 18, 30 and 32 and the cushioning pad 200 can be heated in order to melt the pre-forms, such that they conform to and bond with the outer layer of the medallions 18, 30 and 32.

As noted above, the plurality of medallions 20 are spaced apart and interconnected by a plurality of channels 38. For each of discussion, the “channels” will be referred to hereinafter as hinges throughout the description. As shown in FIG. 7, hinges 38 have a width “W₁” defined by the spacing between the perimeter of adjacent medallions, a depth “D₁” defined by the spacing between the upper surface 34 of the medallions and the upper surface 10 of the pad 100, and a thickness “T₁” defined by the combined thicknesses of the inner and outer layers 16,17 and the cushioning material 15 disposed between the layers. The width W₁ of the hinges 38 can be varied as desired or needed, and can range from as narrow as about 1 mil to about 1000 mils, or more. In some instances, it can be desirable for the width “W₁” of the hinges to be as narrow as possible, in order to maximize the protective features of the medallions, while maintaining the flexibility of the pads. Such applications would include applications in which maximum protection is desired, or in which the hinge is intended to wrap around a corner. Where impact protection is desired, the width of the hinges can be designed to be narrower than the width of the object which would impact the pad. In such instances, the width W₁ can range from about 1 mil to about 10 mils, more particularly from about 3 mils to about 7 mils, and more particularly still about 5 mils.

In other instances, in which the protective features are less important, it can be desirable for the width “W₁” of the hinges to be much wider, in order to maximize the aesthetic feature of the hinges, which can be made to contrast in color with the medallions. In such instances, the width W₁ can be in the millimeter or centimeter range, or even greater, if desired.

The hinges 38 may be linear or curved, depending on the shape of the medallions. The depth of the hinges between the medallions may be the same or different, and the depth may vary along the hinge. Both curved and linear hinges may be used in combination in the pads, as in the present embodiment, and may include a combination of curved and linear hinged areas.

In the present embodiment, the thickness of the cushioning layer 15 disposed between the upper and lower layers 16,17 in hinges 38 may be minimized during the manufacturing process, such that its thickness approaches zero in the hinges 38. As a result, the cushioning material in the hinges 38 may not be visible to the naked eye, or only detectable using very sensitive thickness gauges.

The residual cushioning material 15 remaining in between layers 16,17, if any, assists in bonding layers 16,17 together in the hinges 38. Depending on the materials used, the bonding between layers 16,17 may be at least partially a chemical, thermal and/or mechanical bond. For example, if the material used as the cushioning layer is a resin, the residual resin in the hinges 38 can function as an adhesive to bond layers 16,17 together. Use of the resin as a bonding agent is advantageous, because it eliminates the need for a separate adhesive in the very thin hinge areas, and it keeps the bond consistent and equally flexible throughout pad, thereby enhancing the durability of the pad.

Alternatively, if a fabric is used as one of layers 16,17, the bond between the layers in the hinges may be at least partially mechanical, as a result of the resin being squeezed into opening or pores in the fabric, such that portions of layers 16,17 bond during manufacturing, resulting in “islands” of bonded layers 15,16,17 disposed between islands of bonded layers 16,17.

By minimizing or eliminating any residual cushioning material 15 in hinges 38, the flexibility of the hinges is maximized, such that the entire pad 100 is capable of bending, flexing, folding and twisting in a variety of direction.

As noted above, the outer and inner layers 16,17 are optional, but they may be desirable for many reasons, particularly when the cushioning layer 15 is a cellular material, and/or is a material that does not easily retain its shape.

For example, in the embodiments described above, both the outer and inner layers 16,17 are continuously bonded to cushioning layer 15 across the entire pads, including in the hinges. Depending on the construction of the pad, the outer and inner layers may be bonded to cushioning layer 15, or they may be bonded to each other, when the amount of material in the hinges is minimized or eliminated. One significant advantage of bonding the front layer to cushioning layer 15 is to provide a continuous, uninterrupted surface above and below cushioning layer 15 i.e., to encapsulate cushioning layer 15, other than at the perimeter of the pad. The continuous upper and lower layers strengthen the hinge and groove areas, minimizing breakage in the hinges and/or grooves, which may otherwise occur due to the flexing of the pad during use, because the hinges and/or grooves are thinner than the medallions. At least one bonded layer may be used for the protection of the thin hinge areas during flexing. A thermoplastic polyurethane film, when used as the outer layer 16, is particularly good at preventing cracking or breaking of layer 17 in the hinges or grooves. The inner layer can also provide strength to the hinges or grooves if bonded to the foam, or in many embodiments, both inner and outer layers are bonded to the foam. In cases where the hinge thickness is very low, especially with little or no film in the hinge, both inner and outer bonded layers are desirable to maintain the structural integrity of the pads. It is desirable to use a material with substantial elasticity for the inner and outer layers, such as TPE films, spandex fabrics, and the like. In some embodiments, the use of a fabric with a laminated film backing may be desirable as an inside or outside layer. An inner layer that is a laminate of a fabric and a film, such as a polyurethane film laminate, can be very desirable for maximizing the durability of the hinges.

Optionally, and as disclosed in co-pending and commonly owned U.S. application Ser. No. 13/208,229, filed on Aug. 11, 2011, which is incorporated herein by reference in its entirety, the upper surfaces 34 of the medallions may be contoured using a variety of geometries, including planar surfaces, curved surfaces, and combinations of planar and curved surfaces. Alternatively, the upper surface 34 of a medallion may comprise a surface that is defined by a thickness that generally decreases radially toward the perimeter of the medallion, or toward the perimeter of the pad.

The present pads may be manufactured using techniques disclosed in U.S. Pat. No. 7,827,704 and U.S. Publication Nos. US 2008/0034614 and US 2009/0255625, which are incorporated herein by reference in their entirety. The molds for the present pads are designed to allow layers 15,16,17 to be compressed together under conditions sufficient to minimize or eliminate the foam in the hinges 38,50,60, for certain embodiments of the pads, while allowing the layers to bond together, which may be a chemical, thermal and/or mechanical bond.

As described above, another aspect of the present disclosure is the integration of the above-described pad into garments, particularly compression garments, to protect specific areas of the body. When one of the foregoing pads is integrated into a compression sleeve or garment that is tightly fitting to the wearer, the hinged and/or grooved multilayer pad structure is sewn, adhered or otherwise attached to a spandex fabric or otherwise stretchable material in such a way that the hinged pads are held in form fitting contact with the area to be protected. The pad can be sewn to the inside or outside of a garment. It may be desirable to have the pad cover only a portion of the full circumference of the sleeve, so that the sleeve can still stretch significantly to fit the wearer. The integration of the uniquely hinged protective pad with the compression garment offers particular synergies by creating a simple way to add a significant impact absorbing pad to specific body areas, without altering the entire garment.

When integrated into a compression sleeve, the pad can be in continuous intimate contact with the joint to be protected, which may be desirable when protecting flexible joints such as knees, elbows, shoulders and ankles, because properly designed hinges allow the protective sleeves to naturally remain in the correct position and orientation. When hinges are properly designed, the protective compression sleeve moves as one with the arm, allowing much wider range of motion than traditional padding.

Also, with the protective sleeve in intimate contact with the joint and skin, there is no additional impact caused by the pad hitting the skin or joint after impact from an outside object. Stiffer pads may not be capable of being in continuous contact with the specific body area or joint, because they are not flexible or form-fitting. If not form-fitted, the pads may become part of the impact that injures the wearer. Pads in a sleeve configuration are uniquely better able to protect a moving joint, because they can wrap around a wide radius, and in some instances provide 360 degrees of protection by wrapping the entire joint. In general, it is desirable to leave some area of the compression sleeve without the additional padding layers, to allow the sleeve to stretch and conform better to the arm.

The garments can also be made from a wicking fabric that is designed to move moisture away from the skin layer.

The present pads also may be designed to enhance air and/or moisture transmission, without significantly compromising protection, which is not an option with other protective padding. The use of a spacer fabric or wicking fabric as the inner layer or in combination with a TPE film layer as the inner layer, can enhance comfort as well and wick moisture through the hinges. Also, the use of a high moisture vapor transmissive (“MVT”) film layer can further enhance comfort. Such films can function by chemical absorption/desorption. Examples of such films are available under the product name Sympatex, or TX1540 from Omniflex. The use of microporous high MVT films such as Goretex or Porelle (by Porvair) can also be used, or other similar films.

In any or all of foregoing embodiments, the cushioning layer 15 can comprise one or more layers of any material or combination of materials having sufficient structural integrity to be formed into predetermined shapes, such as by molding, and that are capable of withstanding the environment in which they are intended to be used, without substantial degradation.

The material type and composition can be selected to provide articles and/or regions of articles with predetermined material characteristics, which can be used to customize the pads for specific applications such as cushioning, impact resistance, wear resistance, and the like. Examples of suitable materials include polymeric materials, composite materials, and the like. Examples of suitable polymeric materials include, but are not limited to, thermosetting polymeric materials, elastomeric polymeric materials, thermoplastic materials, including thermoplastic elastomeric materials, and combinations comprising at least one of the foregoing. Some possible polymeric materials include, but are not limited to, polyurethane, silicone, and/or the like, and combinations comprising at least one of the foregoing materials.

In some instances, it may be desirable for the pad to have cushioning characteristics to provide a soft, pliable and comfortable feel such as when used in contact with a body. In such instances, it has been found that some polymeric gels may be suitable for the cushioning layer 15. One example of a suitable polymeric gel is a polyurethane gel comprising a durometer ranging from about 0.01 Shore 00 to less than or equal to about 70 Shore A, more particularly less than 70 Shore 00, more particularly still less than 60 Shore 00. The material can comprise a durometer ranging from about 30 Shore 000 to about 88 Shore D. The durometer of the polymer can be determined by those of ordinary skill in the art using tools such as durometers or penetrometers. Formation of the gel can take place by a variety of methods known to those of skill in the art. For example, formation of a polyurethane gel can comprise reacting suitable pre-polymeric precursor materials e.g., reacting a polyol and an isocyanate in the presence of a catalyst.

In some instances, it may be desirable for the pad to be lightweight, and in such instances, the cushioning material 15 may comprise a foam material, such as a low density foam material. Examples of suitable low density foams include polyester and polyether polyurethane foams.

In some instances, it may be desirable for the pad to be capable of providing impact resistance. In such instances, various types of impact absorbing materials have been found suitable for the cushioning material, particularly energy absorbing foams. For such applications, it can be desirable for such foams to have a density ranging from about 5 to about 35 pounds per cubic foot (pcf), more particularly from about 10 to about 30 pcf, and more particularly still from about 15 to about 25 pa. Suitable rate dependent foams are available from Rogers Corporation under the brand names PORON® and PORON XRD®, which are open cell, microcellular polyurethane foams.

In some instances, it may be desirable for the pad to have combinations of different functional characteristics. For example, in some instances it may be desirable for the pad, or selected medallions on the cushioning pad, to be capable of providing impact resistance, and for the pad to provide a soft, pliable and comfortable feel such as when used in contact with a body. In such instances, the cushioning layer can comprise two or more layers of different materials. For example, the pad may be formed such that the cushioning layer comprises a layer of rate dependent foam adjacent to the outer layer 16, and a layer of low durometer polymeric gel adjacent to the inner layer 15.

In all of the foregoing embodiments, the optional outer layer 16 can comprise any material capable of providing sufficient elasticity to prevent tearing and/or stretching when a force is applied thereto; sufficient structural integrity to be formed into predetermined shapes; and that is capable of withstanding the environment in which it is intended to be used (e.g., repetitive deformations such as twisting, bending, flexing, stretching, and the like), without substantial degradation. The outer layer 16 also can be selected to facilitate the handling of layer 15, which can comprise adhesive characteristics, in some instances. Therefore, the outer layer 16 can be selected to provide a relatively non-tacky surface and smooth surface to the human touch, after molding.

Outer layer 16 can comprise any thickness, and the thickness can be varied depending upon the application. The desired thickness for a particular application can be determined using routine experimentation by those of ordinary skill in the art. Outer layer 16 can comprise a thickness ranging from about 0.2 milli-inches (hereinafter “mil”) to about 60 mils, more particularly from about 0.5 mils to about 30 mils, and more particularly still from about 1.0 mil to about 15 mils.

In instances in which the hand-feel of the products is important, it has been found desirable to minimize the thickness of the outer layer. Therefore, in such products it can be desirable to use the thinnest outer layer possible without sacrificing durability. For example, for applications in which a relatively thin outer layer 16 is desirable, it can comprise a thickness ranging from about 0.2 mil to about 6 mil, more particularly from about 0.5 mil to about 3 mil, and more particularly still from about 0.6 mil to about 2 mil.

In some instances, it can be desirable to use a thicker outer layer 16, which can provide increased durability in comparison to thinner outer layers. For example, when the present materials are used in vibration dampening applications, it can be desirable for the thickness of the outer layer 16 to be about 50 to about 60 mil. Alternatively, thicker layers can be desirable when the cushioning layer is tacky, because the tacky material can be exposed if the outer layer 16 is punctured, making the products difficult to handle.

When the present products are formed using a thermoforming process, it can be desirable to use an outer layer having a thickness of up to about % inch, and even thicker in some instances when desired or necessary. It has been found that it is possible to maintain very soft pliability for outer layers having a thickness of as much as 6 mil or more by applying heat and/or a vacuum during the thermoforming process.

Outer layer 16 can be applied as a sheet of material during the molding process. In the form of a sheet, and especially when the outer layer is relatively thin, the material can be very flexible and may wrinkle and/or fold very easily during handling. Therefore, the outer layer 16 also can comprise a support layer (not illustrated), which assists in handling the material. Alternatively, the outer layer may also be applied as a coating of material during or after the molding process, using a variety of techniques known to those of skill in the art.

Suitable materials for the outer layer 16 include plastics, elastomeric materials such as rubber, thermoplastic elastomers (“TPE”), and/or the like, and combinations comprising at least one of the foregoing materials. Examples of plastics that can be used for the outer layer include, but are not limited to, ethylene-vinyl acetate (“EVA”), nylon, polyester, polyethylene, polyolefin, polyurethane, polyvinyl chloride (“PVC”), polystyrenes, polytetrafluoroethylene (“PTFE”), latex rubber, silicone, vinyl, and combinations thereof.

Other possible materials for the outer layer 16 include a variety of other synthetic and/or non-synthetic materials including, but not limited to, paper, fabric, spacer fabrics, metal, metallized plastic, plastic film, metal foil, and/or the like, as well as composites and/or combinations comprising at least one of the foregoing. Other durable materials can be used for the outer layer including knit, woven and nonwoven fabrics, leather, vinyl or any other suitable material. Use of a fabric layer as outer layer 16 can be advantageous because it can trap and disperse air bubbles that may otherwise form in or between the layers, resulting in a better appearance for the final molded products. Use of a spacer fabric as the outer layer can maximize the airflow.

It can be desirable to use materials for the outer layer than are somewhat elastic; therefore, stretchy fabrics, such as spandex fabrics, can be desirable. The use of stretch fabric as the outer layer can be desirable because it can improve the flexing of the hinges and grooves, and the forming of the outer layer into a contoured shape. In some cases, heating or otherwise forming or pre-stretching materials with more limited stretch, can improve the molding process.

When outer layer 16 comprises a fabric layer, the fabric can be knit, woven, non-woven, synthetic, non-synthetic, and combinations comprising at least one of the foregoing, and the fabric layer can be laminated to, for example, a TPE film. When the pad application requires stretch, then use of an outer layer with elongation may be desirable, and when the outer layer is a laminate, it may be desirable for each layer in the laminate to elongate.

As noted above, it can be desirable to use materials for the outer layer than are somewhat elastic, such as the TPE materials mentioned above. Such TPE materials also can be desirable because they are available as films, in relatively low thicknesses. Any film thickness can be used provided it is compatible with the method of molding and suitable for the intended application, but film thicknesses of between about 1 mil and about 10 mils are desirable. Thicker films are more durable, but thinner films are less expensive, and may provide a softer feel. There are other reasons to choose thicker films, such as when thermoforming deeper shapes, as described later herein. While films thinner than 1 mil or thicker than 10 mils can be used in such applications, it may be desirable to use thicker films. The use of a film rather than a fabric as the outside layer can make the product easy to clean and protect the cushioning material from damage and dirt. The films can comprise an elongation of about 100 percent (%) to about 1500%, more particularly about 200% to about 1000%, and more particularly still about 300% to about 700%”.

Some possible TPE materials include styrenic block copolymers, polyolefin blends, elastomeric alloys, thermoplastic polyurethanes, thermoplastic copolyester, thermoplastic polyamides, and combinations thereof. Examples of commercially available elastomeric alloys include melt-processable rubbers and thermoplastic vulcanizates. Examples of suitable TPEs include thermoplastic polyurethanes (“TPU”). TPU film can be desirable due to its combination of durability, elasticity, softness and flexibility. One suitable film is a polyester polyurethane film available from Deerfield Urethane, a Bayer Material Science Company, under the product name Dureflex PS5400. It can be desirable to use a polyester TPU film, rather than a polyether TPU film, because the polyester TPU film, in addition to having improved abrasion resistance in comparison to polyether TPU film, also performs unexpectedly well under high humidity conditions, such as in athletic clothing and commercial laundering.

Additionally, pads and garments can be manufactured with both fabric and film on different parts of the pad, allowing for full range of motion and further protection from the use of both materials. It may be desirable that the outer layer be a composite of a fabric and film so that the film aids in protecting the hinge during flexing and can also serve as a protective barrier for the cushioning material.

In any or all of foregoing embodiments, inner layer 17 can comprise the same materials as the outer layer 16. When inner layer 17 comprises a fabric layer, the fabric can be knit, woven, non-woven, synthetic, non-synthetic, and combinations comprising at least one of the foregoing, and the fabric layer can be laminated to, for example, a TPE film. When the pad application requires stretch, then use of an inner layer with elongation may be desirable, and when the inner layer is a laminate, it may be desirable for each layer in the laminate to elongate. Use of a fabric layer as inner layer 17 can be advantageous because it can trap and disperse air bubbles that may otherwise form in or between the layers, resulting in a better appearance for the final molded products.

The use of active agents in one or more of the inner layer, outer layer and/or the cushioning layer can be desirable. For example, the addition of a silver or copper based active agent can provide the material with antimicrobial or antifungal properties. The use of actives in the inner or outer layer or the foam itself can be desirable, such as the addition of silver or copper based actives to act as an antimicrobial or antifungal agent.

One or both of inner and outer layers 16,17 also can comprise color, graphics and/or indicia, including text. The color, graphics and/or indicia disposed on such layers can be transmitted through other layers when they are formed from colorless and/or transparent materials, which can be desirable for aesthetic and costs reasons. In addition, if desired, one or both of inner and outer layers 16,17 also can be fluid-permeable. “Fluid-permeable,” as used herein, means that the material from which the layer is formed is open to passage or entrance of a fluid material.

The size, shape, configuration, orientation and dimensions of the pad, medallions, medallion contours, hinges, grooves and flange may be varied as desired in order to achieve the desired characteristics for the pad design. All of the foregoing features, alone or in combination, are designed to facilitate the flexibility of the pad either inwardly or outwardly to conform to a user's body during movement. However, it should be understood that in each of the foregoing embodiments, and in any pad according to the present disclosure, all of the foregoing measurements can vary depending on the desired characteristics and design of the pad. For example, the pads are designed to provide a variety of characteristics such as, but not limited to, cushioning, breathabiltity, ventilation, vibration dampening and/or impact absorption, and the like. The characteristics of the pad may be varied by changing the thickness and/or material type of cushioning layer 15 in the medallions, changing the size, shape, number and position of the vents; changing the spacing between the medallions (i.e., the width of the hinges), and/or changing the contours of the medallions, and the like. For example, using a gel for cushioning layer 15 provides a pad with cushioning and vibration dampening characteristics; using a foam decreases the weight of the pad; using a rate dependent or impact absorbing foam increases the impact absorption of the pad; etc. In general, increasing the thickness of the cushioning layer 15 in the medallions generally increases the foregoing characteristics; and using a combination of materials for cushioning layer 15 may provide a combination of characteristics.

In any or all of foregoing embodiments, and in any pad according to the present disclosure, the hinges are designed to provide flexibility to the pad in targeted areas in which flexibility is desired or needed. Using curved, parallel and/or intersecting hinges allows the flexibility of the pad to be tailored to specific functions, such as protecting joints during motion. The width, depth, orientation and position of the hinges may vary, depending on a number of factors including, but not limited to, the desired amount and location of flexibility for the pad.

The flexibility of the hinges can be varied, by varying the thickness of the material in the hinge regions. For example, decreasing the thickness of the material in the hinges increases the flexibility of the pad, and increasing the thickness of the material in the hinge regions decreases the flexibility. In some embodiments that include one or both of the inner and outer layers 16,17, it is possible to “squeeze” the cushioning layer 15 in the hinges to minimize or eliminate the amount of material in the hinge region. In such embodiments, maximum flexibility can be achieved when the thickness of the cushioning layer 15 approaches zero in the hinges, or when the pad is molded without cushioning layer 15 in the hinges 38. For example, when using inner and outer layers 16,17 with thicknesses of about 4 mils, it is possible to achieve hinge thicknesses approaching 8 mils, or approaching the combined thickness of the inner and outer layers 16,17, by removing as much cushioning material 15 from the hinge area, as is possible during the molding process.

Thus, relatively higher levels of protection may be achieved using a hinge depth of less than about 20% of the medallion thickness, more particularly less than about 10% of the medallion thickness, and more particularly still less than about 5% of the medallion thickness. Successful parts have been made with hinge depths of 0.020″, 0.040″ and up to 0.080″.

When the pads are molded with a front layer, a back layer, or both layers, the maximum pad flexibility may be achieved when the hinge thickness approximately corresponds to the combined thickness of the layer(s) other than layer 15, or when the thickness of the cushioning layer 15 approaches zero.

Deep hinges can also have some foam thickness, and still provide great mobility. As noted below, one feature of the present protective pads is that the outer and/or inner layers can protect the cushioning layer from breaking at the relatively thin hinge regions during repetitive flexing, so the foam thickness is not limited by the foam flex strength, as long as the foam is bonded to either or both inner and outer layers.

In each of the foregoing embodiments, and in any pad according to the present disclosure, the width of the hinges, or spacing between the medallions, is designed to allow the pad to bend as much as possible, while still retaining the protective characteristics of the medallions. Therefore, the spacing between the medallions can be determined by the amount of distance needed to have a flexible hinge, while minimizing the spacing between the medallions. Thus, relatively higher levels of protection may be achieved using a hinge width of less than about 20% of the medallion thickness, more particularly less than about 10% of the medallion thickness, and more particularly still less than about 5% of the medallion thickness. As noted above, the use of angled or saw-toothed shaped hinges and/or grooves (not illustrated) can also reduce the amount of exposed unprotected surface.

In any or all of foregoing embodiments, the pads may be formed such that the foam has a generally uniform density throughout the pad. Specifically, in some instances it may be desirable not to compress the foam in the grooves or hinges during molding or forming, because the compression increases the density of the foam, which tends to reduce the range of motion and provide non-uniform padding levels by eliminating foam. The contoured medallions and variations in foam thickness not only provide an aesthetically pleasing pad, but they also provide maximal protection where protection is most needed, and less protection where less is needed. By using uniform foam density and varying thickness where needed, the weight of the pad is reduced, and the range of motion is increased. Using thermoforming or compression to take foam and compress areas to shape may increase density in those areas and create additional weight, uneven protection and less range of motion.

The pad construction, with inner and outer film layers, allow the manufacturer to make the gaps between sections of the pad smaller, because it is not necessary to use fabric to locate and position the pad. It also allows the manufacturer to angle and shape the grooves and hinges in the most appropriate way to cover and protect the wearer fully while stretching, fitting, and remaining in place during the activity.

Use of an exposed protective foam pad, in contrast to a pad enclosed in a pocket, fabric or flexible film, provides protection for individuals wearing supportive or corrective braces, such as knee braces, ankle supports, back supports, and the like. Thus, the pads can be attached or adhered to mechanical supports to protect adaptive mobility athletes from themselves and from other athletes with similar braces. Similarly, the design of pads according to the present disclosure can be customized and adhered to braces worn by conventionally mobile athletes. This provides protection to both the wearer of the brace but also other athletes who come in contact with the corrective brace. One example of such a brace is the padding on knee braces used in professional football.

The present pads can also be used on shin guards worn by youth, adult and professional soccer players. The properties of impact absorbing foam padding in combination with form fitting garments provides unique and highly accurate protection of targeted body parts. Therefore, one embodiment of this disclosure is flexible, form-fitting breathable shin and ankle guards for soccer players. Significantly, such shin and ankle guards provide more protection to soccer players due to the closer fit of the foam, more comfort from the wicking materials, venting and perforation used in construction, and a more durable product than, for example, non-breathable, hard plastic pad held in place with straps or friction of the user's sock.

The foam padding and other layers as noted earlier can be designed with perforations either throughout the material, or within the groove or hinge areas, without significant deterioration of the protection. The fact that all layers of the pad are continuously bonded together, in some embodiments, allows the transpiration of water vapor to pass more easily through pre-established pathways. Once the moisture is wicked into the fabric layer, it can be channeled out through the pads because the surfaces are bonded. This is an important distinction from other pads, which have one or more of the layers free floating, making them more uncomfortable to wear.

Pads comprising continuous inner and outer layers that are bonded to cushioning layer 15 in the medallions, hinges and grooves, provide free range of motion and a durable pad, because it allows the pad to flex and hinge along with the specific area of the body without degradation. The fact that the pad has a continuous inner surface, outer surface or both, maintains the orientation and position of the hinges, as well as the spacing. The present pads are in contrast to pads and garments in which foam has been cut, scored, or molded in separate pieces, to form the hinges, which can allow too much stretch between the pads and allow injury to the user. The present protective pads allow the fixed orientation of the pads. This feature may be less desirable for application in which significantly moving joint areas are not being protected, and are just making generalized shirt or pant padding.

The integration of the pad into a compression or form-fitting garment allows protection to specific areas of the body including joints; the protection is not just from outside impact. Use of such compression or form-fitting garments with the present pads keeps the pad from separating from the skin prior to impact, which may cause secondary impact to the body.

In certain embodiments, the fact that the outside surface (fabric or film) is (in some embodiments) the actual outside surface of the garment or sleeve is an important distinction. Pads that have unbonded fabric or other covering sewn across the outside, covering the padding, allow slippage of the outer layer across the padding on impact, which affects the precision of the impact protection. When wearing the current garments, the wearer has the pad on the exterior of a form-fitted garment, and enjoys more accurate protection of the specific body area or joint. Having the exposed outer layer of the present disclosure pad as the outside layer of the garment or sleeve (as shown in FIGS. 12 and 13), also allows improved moisture or air flow management, which is superior to cut foam pieces with any form of loose cover. Precision vents and air channels minimize heat and moisture build-up. In addition, embodiments with the outside surface of the pad exposed allow for the inside of a form fitting garment to lie flat against the user's skin, as the inside surface of the pad can generally be flat. When attached to the outside of an elastic fabric, the user can have an uninterrupted layer of elastic fabric or other material against the skin. This allows the pad to closely hug the skin surface, and also to have a more seam-free interior surface which is less likely to cause abrasions or irritations to the skin.

It should be noted that the terms “first,” “second,” and the like herein do not denote any order or importance, but rather are used to distinguish one element from another, and the terms “a” and “an” herein do not denote a limitation of quantity, but rather denote the presence of at least one of the referenced items. Similarly, it is noted that the terms “bottom” and “top” are used herein, unless otherwise noted, merely for convenience of description, and are not limited to any one position or spatial orientation. In addition, the modifier “about” used in connection with a quantity is inclusive of the stated value and has the meaning dictated by the context (e.g., includes the degree of error associated with measurement of the particular quantity).

Compounds are described herein using standard nomenclature. For example, any position not substituted by an indicated group is understood to have its valency filled by a bond as indicated, or a hydrogen atom A dash (“—”) that is not between two letters or symbols is used to indicate a point of attachment for a substituent. For example, —CHO is attached through the carbon of the carbonyl group. Unless defined otherwise herein, all percentages herein mean weight percent (“wt. %”). Furthermore, all ranges disclosed herein are inclusive and combinable (e.g., ranges of “up to about 25 weight percent (wt. %), with about 5 wt. % to about 20 wt. % desired, and about 10 wt. % to about 15 wt. % more desired,” are inclusive of the endpoints and all intermediate values of the ranges, e.g., “about 5 wt. % to about 25 wt. %, about 5 wt. % to about 15 wt. %”, etc.). The notation “+/−10%” means that the indicated measurement may be from an amount that is minus 10% to an amount that is plus 10% of the stated value.

Finally, unless defined otherwise, technical and scientific terms used herein have the same meaning as is commonly understood by one of skill in the art to which this disclosure belongs.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A cushioning pad, comprising:
a cushioning region comprising an upper surface, a lower surface, a thickness and a width, the cushioning region comprising a cushioning material disposed between and continuously bonded to a continuous upper layer and a continuous lower layer;
a channel disposed around and defining the cushioning region, the channel comprising a thickness less than the thickness of a cushioning region, the channel further comprising the continuous upper layer and the continuous lower layer, the continuous upper layer at least partially bonded to the continuous lower layer,
a sidewall extending downwardly from the upper surface of the cushioning region;
and an abrasion resistant and slideable layer disposed at the upper layer.

2. The cushioning pad of claim 1, wherein the continuous upper layer is the abrasion resistant and slideable layer.

3. The cushioning pad of claim 1, wherein the abrasion resistant and slideable layer is disposed over the continuous upper layer.

4. The cushioning pad of claim 1, wherein the abrasion resistant and slideable layer is a ballistic material.

5. The cushioning pad of claim 2, wherein the abrasion resistant and slideable layer is a ballistic material.

6. The cushioning pad of claim 3, wherein the abrasion resistant and slideable layer is a ballistic material.

7. The cushioning pad of claim 4, wherein the ballistic material is a ballistic fabric attached to the upper surface of the cushioning region.

8. The cushioning pad of claim 5, wherein the ballistic material is a ballistic fabric attached to the upper surface of the cushioning region.

9. The cushioning pad of claim 6, wherein the ballistic material is a ballistic fabric attached to the upper surface of the cushioning region.

10. The cushioning pad of claim 1, wherein the abrasion resistant and slideable layer comprises a shell disposed over the cushioning region.

11. The cushioning pad of claim 3, wherein the abrasion resistant and slideable layer comprises a shell disposed over the cushioning region.

12. The cushioning pad of claim 6, wherein the shell is a pre-formed shell.

13. The cushioning pad of claim 6, wherein the shell is a pre-formed shell.

14. The cushioning pad of claim 6, wherein the shell is a hard shell.

15. The cushioning pad of claim 11, wherein the shell is a hard shell.

16. The cushioning pad of claim 6, wherein the shell conforms to the upper surface of the cushioning region.

17. The cushioning pad of claim 7, wherein the shell conforms to the upper surface of the cushioning region.

18. The cushioning pad of claim 8, wherein the shell conforms to the upper surface of the cushioning region.

19. The cushioning pad of claim 6, wherein the shell comprises a flange that extends at least partially down the sidewall.

20. The cushioning pad of claim 7, wherein the shell comprises a flange that extends at least partially down the sidewall.

21. The cushioning pad of claim 8, wherein the shell comprises a flange that extends at least partially down the sidewall.

22. The cushioning pad of claim 9, wherein the shell comprises a flange that extends at least partially down the sidewall.

23. The cushioning pad of claim 19, wherein the flange is tapered.

24. The cushioning pad of claim 20, wherein the flange is tapered.

25. The cushioning pad of claim 21, wherein the flange is tapered.

26. The cushioning pad of claim 22, wherein the flange is tapered.
